(19) United States
(12) Patent Application Publication
(10) Pub. No.: US 2015/0055569 A1
(43) Pub. Date: Feb. 26, 2015

(54) IDENTIFYING A CHANNEL FOR NETWORK COMMUNICATION

(71) Applicant: QUALCOMM Incorporated, San Diego, CA (US)

(72) Inventors: Shian-De Ju, San Diego, CA (US); Nanxi Chen, San Diego, CA (US); Gregory Robert Lie, San Diego, CA (US)

(73) Assignee: QUALCOMM Incorporated, San Diego, CA (US)

(21) Appl. No.: 14/186,734

(22) Filed: Feb. 21, 2014

Related U.S. Application Data
(60) Provisional application No. 61/869,534, filed on Aug. 23, 2013.

(51) Int. Cl. H04W 76/02; H04W 72/04

(52) U.S. Cl. CPC H04W 76/021; H04W 72/048
USPC 370/329

(57) ABSTRACT

Communication devices configured to identify a channel for network communication are disclosed. For example, an apparatus operable in a wireless communication network can receive a message that specifies a list of channels in operation in a network, remove at least one channel from the list of channels, and identify a channel from among the list of channels other than the at least one removed channel for communication with the network. The apparatus may be able to increase the likelihood that it will acquire the network, even though the network may be utilizing one or more channels that are not supported by the apparatus. Other aspects, embodiments, and features are also disclosed and claimed.

### CROSS-REFERENCE TO RELATED APPLICATIONS

This application claims priority to and the benefit of provisional patent application No. 61/869,534 filed in the U.S. patent office on Aug. 23, 2013, the entire content of which is incorporated herein by reference.

### TECHNICAL FIELD

The technology discussed below relates generally to wireless communication, and more specifically, but not exclusively, to identifying a channel in a wireless communication network. Implementations of the technology can provide efficient channel acquisition (e.g., during roaming scenarios) for efficient use of power resources and reliable user experience.

### BACKGROUND

Wireless communication systems are widely deployed to provide various types of communication content such as voice, video, packet data, messaging, broadcast, and so on. These systems may be accessed by various types of access terminals (e.g., mobile devices) adapted to facilitate wireless communication, where multiple access terminals share available system resources (e.g., time, frequency, and power).

System or channel acquisition is a process that a mobile device may use to establish a communication link or channel with a wireless network. For channel acquisition to take place, the mobile device must first find an available channel that it can use. This can be accomplished by receiving overhead messages containing a list of available channels, and selecting an available channel.

As the demand for mobile broadband access continues to increase, research and development continue to advance the technology not only to meet the growing demand for mobile broadband access, but to advance and enhance the user experience with mobile communication.

### BRIEF SUMMARY OF SOME EXAMPLES

The following presents a simplified summary of one or more aspects of the present disclosure, in order to provide a basic understanding of such aspects. This summary is not an extensive overview of all contemplated features of the disclosure, and is intended neither to identify key or critical elements of all aspects of the disclosure nor to delineate the scope of any or all aspects of the disclosure. Its sole purpose is to present some concepts of one or more aspects of the disclosure in a simplified form as a prelude to the more detailed description that is presented later.

Various aspects of the disclosure provide for identifying a channel for communication with a network based on a list of channels in operation in the network. An apparatus such as an access terminal that receives the list autonomously removes any channel in the list that is not supported by the apparatus. For example, a low-cost apparatus may have a limited hardware configuration that only supports some of the channels that are in operation in the network. The apparatus identifies a channel for communication with the network from the list of channels, exclusive of any removed channels. In this way, the apparatus may be able to increase the likelihood that it will acquire the network, even though the network may be utilizing one or more channels that are not supported by the apparatus.

For example, in one aspect, the disclosure provides a method of wireless communication operable at an access terminal. The method includes receiving a message that specifies a list of channels in operation in a network; generating a subset list of channels by removing at least one channel from the list of channels without negotiating with the network to remove the at least one channel from the list of channels; and identifying a channel from the subset list of channels for establishing communication with the network.

Another aspect of the disclosure provides an apparatus configured for wireless communication that includes at least one processing circuit, a memory coupled to the at least one processing circuit, and a communication interface coupled to the at least one processing circuit. The at least one processing circuit is configured to receive a message that specifies a list of channels in operation in a network; generate a subset list of channels by removing at least one channel from the list of channels without negotiating with the network to remove the at least one channel from the list of channels; and identify a channel from the subset list of channels for establishing communication with the network.

Another aspect of the disclosure provides an apparatus configured for wireless communication. The apparatus including means for receiving a message that specifies a list of channels in operation in a network; means for generating a subset list of channels by removing at least one channel from the list of channels without negotiating with the network to remove the at least one channel from the list of channels; and means for identifying a channel from the subset list of channels for establishing communication with the network.

Another aspect of the disclosure provides an article of manufacture comprising a computer-readable storage device comprising code for causing a communication device to receive a message that specifies a list of channels in operation in a network; generate a subset list of channels by removing at least one channel from the list of channels without negotiating with the network to remove the at least one channel from the list of channels; and identify a channel from the subset list of channels for establishing communication with the network.

These and other aspects of the disclosure will become more fully understood upon a review of the detailed description, which follows. Other aspects, features, and embodiments of the present disclosure will become apparent to those of ordinary skill in the art, upon reviewing the following description of specific, exemplary embodiments of the present disclosure in conjunction with the accompanying figures. While features of the present disclosure may be discussed relative to certain embodiments and figures below, all embodiments of the present disclosure can include one or more of the advantageous features discussed herein. In other words, while one or more embodiments may be discussed as having certain advantageous features, one or more of such features may also be used in accordance with the various embodiments of the disclosure discussed herein. In similar fashion, while exemplary embodiments may be discussed below as device, system, or method embodiments it should be understood that such exemplary embodiments can be implemented in various devices, systems, and methods.

### BRIEF DESCRIPTION OF THE DRAWINGS

FIG. 1 is a block diagram illustrating an example of a network environment in which one or more aspects of the present disclosure may find application.

FIG. 2 is a block diagram illustrating an example of a protocol stack architecture which may be implemented by an access terminal.

FIG. 3 is a block diagram illustrating an example of a network environment where an access terminal is configured to identify a channel for communicating with an access network.

FIG. 4 is a flowchart illustrating a method of wireless communication between an access terminal and a network in accordance with some aspects of the disclosure.

FIG. 5 is a block diagram illustrating select components of an access terminal according to at least one example.

FIG. 6 is a flowchart illustrating a method of identifying a channel for communication with a network in accordance with some aspects of the disclosure.

FIG. 7 is a flowchart illustrating additional aspects of a method of identifying a channel for communication with a network in accordance with some aspects of the disclosure.

FIG. 8 is a flowchart illustrating additional aspects of a method of identifying a channel for communication with a network in accordance with some aspects of the disclosure.

FIG. 9 is a flowchart illustrating a method of wireless communication between an access terminal and a network in accordance with some aspects of the disclosure.

FIG. 10 is a block diagram illustrating an example of a base station in communication with an access terminal in a communication network.

### DETAILED DESCRIPTION

The description set forth below in connection with the appended drawings is intended as a description of various configurations and is not intended to represent the only configurations in which the concepts and features described herein may be practiced. The following description includes specific details for the purpose of providing a thorough understanding of various concepts. However, it will be apparent to those skilled in the art that these concepts may be practiced without these specific details. In some instances, well known circuits, structures, techniques and components are shown in block diagram form to avoid obscuring the described concepts and features.

The various concepts presented throughout this disclosure may be implemented across a broad variety of wireless communication systems, network architectures, and communication standards. Certain aspects of the discussions are described below for code division multiple access (CDMA) and 3rd generation partnership project 2 (3GPP2) 1× protocols and systems, and related terminology may be found in much of the following description. However, those of ordinary skill in the art will recognize that one or more aspects of the present disclosure may be employed and included in one or more other wireless communication protocols and systems.

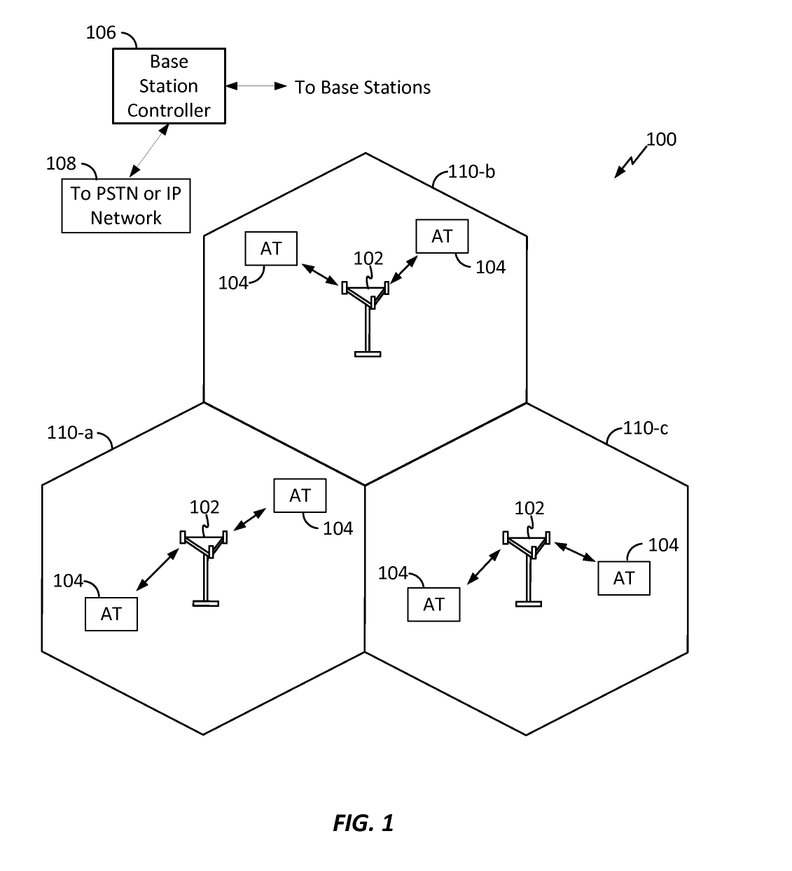

FIG. 1 is a block diagram illustrating an example of a network environment in which one or more aspects of the present disclosure may find application. The wireless communication system 100 generally includes one or more base stations 102, one or more access terminals (ATs) 104, one or more base station controllers (BSC) 106, and a core network 108 providing access to a public switched telephone network (PSTN) (e.g., via a mobile switching center/visitor location register (MSC/VLR)) and/or to an Internet protocol (IP) network (e.g., via a packet data switching node (PDSN)). The system 100 may support operation on multiple carriers (waveform signals of different frequencies). Multi-carrier transmitters can transmit modulated signals simultaneously on the multiple carriers. Each modulated signal may be a CDMA signal, a time division multiple access (TDMA) signal, an orthogonal frequency division multiple access (OFDMA) signal, a single carrier frequency division multiple access (SC-FDMA) signal, etc. Each modulated signal may be sent on a different carrier and may carry control information (e.g., pilot signals), overhead information, data, etc.

The base stations 102 can wirelessly communicate with the access terminals 104 via a base station antenna. The base stations 102 may each be implemented generally as a device adapted to facilitate wireless connectivity (for one or more access terminals 104) to the wireless communication system 100. A base station 102 may also be referred to by those skilled in the art as an access point, a base transceiver station (BTS), an access network, a radio base station, a radio transceiver, a transceiver function, a basic service set (BSS), an extended service set (ESS), a Node B, a femto cell, a pico cell, and/or some other suitable terminology.

The base stations 102 are configured to communicate with the access terminals 104 under the control of the base station controller 106 via multiple carriers. Each of the base stations 102 can provide communication coverage for a respective geographic area. The coverage area 110 for each base station 102 here is identified as cells 110-a, 110-b, or 110-c. The coverage area 110 for a base station 102 may be divided into sectors (not shown, but making up only a portion of the coverage area). In a coverage area 110 that is divided into sectors, the multiple sectors within a coverage area 110 can be formed by groups of antennas with each antenna responsible for communication with one or more access terminals 104 in a portion of the cell.

One or more access terminals 104 may be dispersed throughout the coverage areas 110, and may wirelessly communicate with one or more sectors associated with each respective base station 102. An access terminal 104 may generally include one or more devices that communicate with one or more other devices through wireless signals. Such access terminals 104 may also be referred to by those skilled in the art as a user equipment (UE), a mobile station (MS), a subscriber station, a mobile unit, a subscriber unit, a wireless unit, a remote unit, a mobile device, a wireless device, a wireless communication device, a remote device, a mobile subscriber station, a mobile terminal, a wireless terminal, a remote terminal, a handset, a terminal, a user agent, a mobile client, a client, or some other suitable terminology. The access terminals 104 may include mobile terminals and/or at least substantially fixed terminals. Examples of access terminals 104 include mobile phones, pagers, wireless modems, personal digital assistants, personal information managers (PIMs), personal media players, palmtop computers, laptop computers, tablet computers, televisions, appliances, e-readers, digital video recorders (DVRs), machine-to-machine (M2M) devices, entertainment devices, sensors, wireless appliances, and/or other communication/computing devices which communicate, at least partially, through a wireless or cellular network.

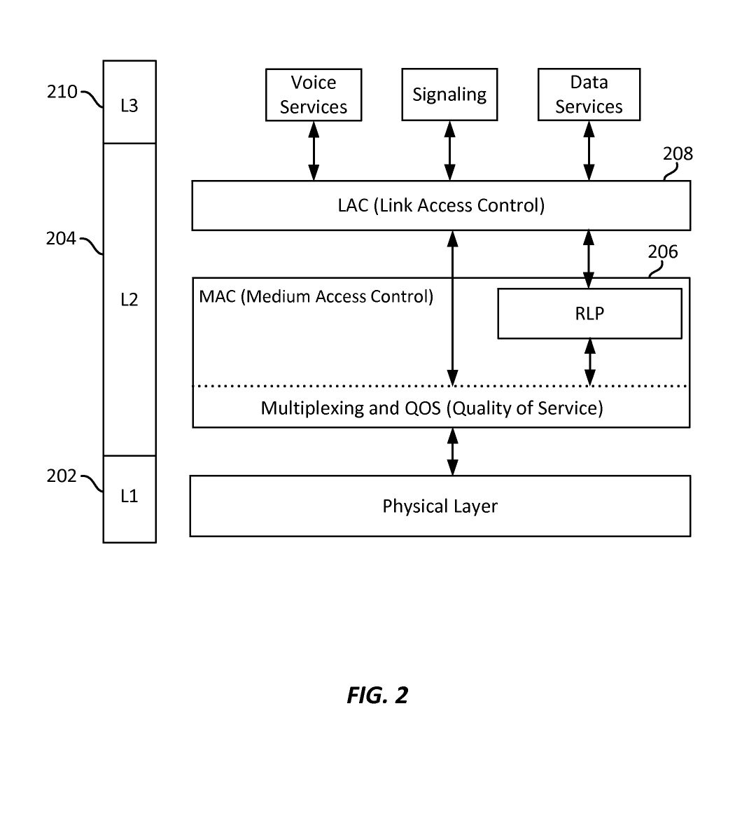

The access terminal 104 may be adapted to employ a protocol stack architecture for communicating data between the access terminal 104 and one or more network nodes of the wireless communication system 100 (e.g., the base station 102). A protocol stack generally includes a conceptual model of the layered architecture for communication protocols in which layers are represented in order of their numeric designation, where transferred data is processed sequentially by each layer, in the order of their representation. Graphically, the “stack” is typically shown vertically, with the layer having the lowest numeric designation at the base. FIG. 2 is a block diagram illustrating an example of a protocol stack architecture which may be implemented by an access terminal 104. Referring to FIGS. 1 and 2, the protocol stack architecture for the access terminal 104 is shown to generally include three layers: Layer 1 (L1), Layer 2 (L2), and Layer 3 (L3).

Layer 1 202 is the lowest layer and implements various physical layer signal processing functions. Layer 1 202 is also referred to herein as the physical layer 202. This physical layer 202 provides for the transmission and reception of radio signals between an access terminal 104 and a base station 102.

The data link layer, called layer 2 (or “the L2 layer”) 204 is above the physical layer 202 and is responsible for delivery of signaling messages generated by Layer 3. The L2 layer 204 makes use of the services provided by the physical layer 202. The L2 layer 204 may include two sublayers: the Medium Access Control (MAC) sublayer 206, and the Link Access Control (LAC) sublayer 208.

The MAC sublayer 206 is the lower sublayer of the L2 layer 204. The MAC sublayer 206 implements the medium access protocol and is responsible for transport of protocol data units associated with the higher layers by using the services provided by the physical layer 202. The MAC sublayer 206 may manage the access of data from the higher layers to the shared air interface. The MAC sublayer 206 also may include or interface with radio link protocol (RLP) functions, multiplexing functions, and QoS functions.

The LAC sublayer 208 is the upper sublayer of the L2 layer 204. The LAC sublayer 208 implements a data link protocol that provides for the correct transport and delivery of signaling messages generated at the layer 3. The LAC sublayer makes use of the services provided by the lower layers (e.g., layer 1 and the MAC sublayer).

Layer 3 210, which may also be referred to as the upper layer or the L3 layer, originates and terminates signaling messages according to the semantics and timing of the communication protocol between a base station 102 and an access terminal 104. The L3 layer 210 makes use of the services provided by the L2 layer. Information (e.g., voice service, data services, and signaling) messages are also passed through the L3 layer 210.

### System/Channel Acquisition

System or channel acquisition is a standard process that an access terminal may utilize to establish a communication channel with an access network. For a channel acquisition to take place, the access terminal must first find an available channel that the access terminal can use to communicate with the access network.

3GPP2 C.S0024-B v 3.0 (September 2009), which is incorporated herein by reference, is the cdma2000 High Rate Packet Data Air Interface specification and defines certain aspects of the Evolved Voice-Data Optimized (EVDO) air interface. According to this specification, a certain overhead message (i.e., a sector parameters (SP) message) transmitted from an access network advertises a list of CDMA channels in operation on the access network. When an access terminal receives the SP message from the access network, the access terminal generally selects a CDMA channel from the list of channels provided on the SP message, and accordingly tunes to the selected CDMA channel. If more than one channel is available as indicated in the SP message, the access terminal utilizes CDMA channel selection algorithm (e.g., a hash function) to compute an index to the channel list provided in the SP message. Basically, by utilizing this hash function, the access network can distribute the various access terminals to different channels, so that every access terminal does not end up on the same channel.

In a conventional system, the access terminal and access network independently run the same hash algorithm so that they select the same channel. According to 3GPP2 standards, different hash algorithms can be run by the access terminal and the access network depending on the Idle State Protocol subtype used by the access terminal and the access network. If an access terminal and an access network negotiate a subtype other than a Default Idle State Protocol, the access terminal and the access network will remove unsupported channels listed in the SP message before hashing. However, if the access terminal and the access network use the Default Idle State Protocol, both the access terminal and the access network run the hash function on all the channels listed in the SP message.

Some hardware implementations of access terminals are configured to support a limited number of channels or band classes (in EVDO, a band class is a group of channels). For example, a low-cost access terminal may be configured only to support one particular band class. However, the access network may list channels from several bands in the SP message. For example, 3GPP2 defines more than 20 band classes.

Moreover, an access terminal that has not established an EVDO session with an access network uses the Default Idle State Protocol by default. Consequently, in some scenarios, it is possible that the access terminal may select a channel that it does not support (i.e., the hash algorithm may hash to an unsupported channel). When this happens, the access terminal might not be able to receive EVDO service, even if supported channels were available in that area.

As one example, assume that an access terminal supports only BandClass (BC) 0. When this access terminal enters a sector with both BC0 and BC1 channels listed in a SectorParameters (SP) message, the access terminal may hash to the BC1 channel, and accordingly, because the access terminal lacks the hardware to support the BC1 channel, the access terminal would fail to acquire the network. After the access terminal fails to tune to the BC1 channel, if there are no other BC0 channels available for the access terminal to re-acquire, the above-described procedures repeat, and the access terminal may repeatedly fail to acquire service.

According to an aspect of the present disclosure, prior to performing channel selection (e.g., running a hash algorithm), an access terminal may autonomously remove one or more unsupported channels from a received channel list (e.g., specified in the SP message). For example, the access terminal may autonomously remove the unsupported channel(s) if the access terminal has not yet negotiated an EVDO session with a network. In this way, channel selection will result in the access terminal selecting a supported channel, thereby enabling communication with the network.

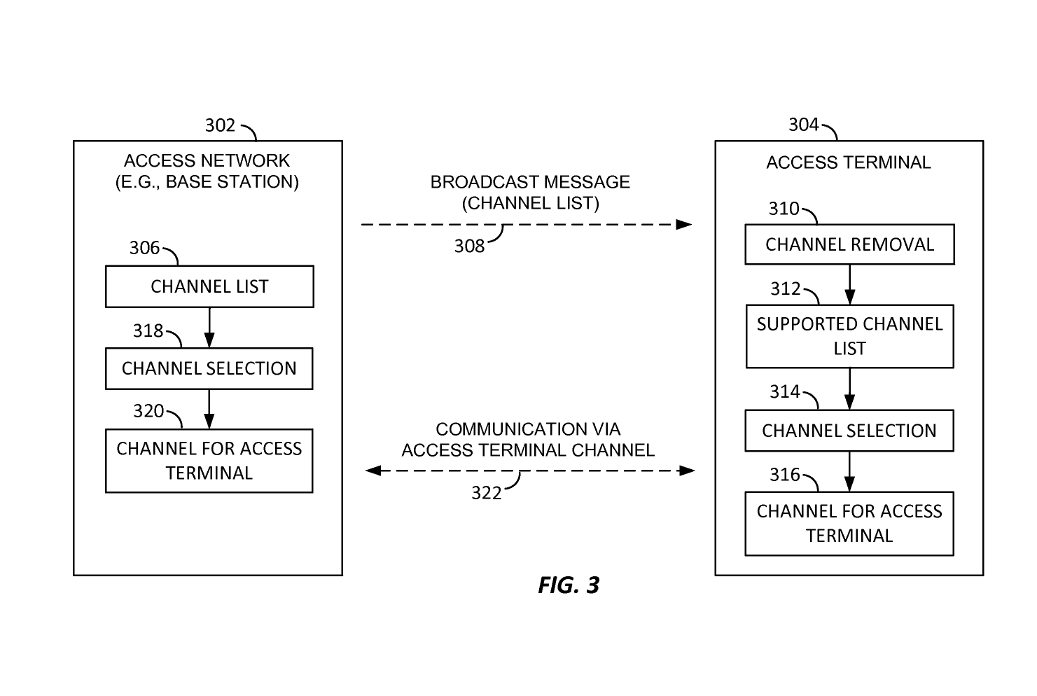

FIG. 3 illustrates a high-level example of signaling and functionality for an access network 302 (e.g., a base station) and an access terminal 304 in accordance with an aspect of the disclosure. The access network 302 maintains a channel list 306 that lists each channel that is currently in operation at the access network 302. The access network 302 also broadcasts a message 308 that includes the channel list.

The access terminal 304 includes channel removal functionality 310 that removes any unsupported channels from the received channel list and stores a supported channel list 312 (e.g., a subset of the channel list 306) that lists the channels that are supported by the access terminal 304. The access terminal also includes channel selection functionality 314 (e.g., executing a hash algorithm) that selects a channel 316 from the supported channel list 312 that will be used by the access terminal 304 to initiate communication 322 with the access network 302.

For example, by running a hash algorithm after removing unsupported channels from the list of channels specified in a received SP message, the access terminal 304 is able to select a supported channel from the list of channels. The access terminal may then utilize this selected channel to negotiate an EVDO session with the access network 302.

The access network 302, in turn, includes channel selection functionality 318 (e.g., executing a hash algorithm) that selects a channel 320 from the channel list 306 that is expected to be used by the access terminal 304 to initiate communication 322 with the access network 302. As indicated above, the access terminal 304 and the access network 302 each independently run the same hash algorithm in an attempt to arrive at the same result. Thus, as a side effect of the autonomous removal of one or more unsupported channels by the access terminal 304, the hash results may be different between the access terminal 304 and the access network 302 before session negotiation. However, the access network 302 generally does not attempt to page the access terminal 304 before EVDO session negotiation. Thus, as described above, after selecting the supported channel, the access terminal 304 may utilize the selected channel to communicate with the access network 302 and negotiate the EVDO session.

If non-Default Idle State Protocol subtypes (e.g., Enhanced Idle State Protocol) are then negotiated for the EVDO session, the access terminal 304 and the access network 304 may both remove any unsupported channels and ultimately select the same hashed channel. If the Default Idle State Protocol is negotiated during session negotiation, and an unsupported channel is selected by the hash algorithm, the access terminal may still lose the system after session negotiation. However, this result complies with the 3GPP2 standards.

Advantageously, by removing unsupported channels from the received list of channels as taught herein, an access terminal will more likely obtain service from a particular access network. Such a scheme can provide great benefit, especially for roaming scenarios, by enabling the access terminal to only hash to a supported channel and thereby have a chance to negotiate the Enhanced Idle State Protocol with the access network. Moreover, such a scheme can lower the power consumption of an access terminal. In general, an access terminal will continually try to acquire a network until it succeeds in doing so. Consequently, an access terminal that that has not acquired a network may consume a relatively large amount of power as it repeatedly attempts to acquire a network. By removing unsupported channels from the received list of channels as taught herein, an access terminal increases its chance of acquiring a network. Consequently, the access terminal can spend more time in IDLE mode and thereby reduce its power consumption.

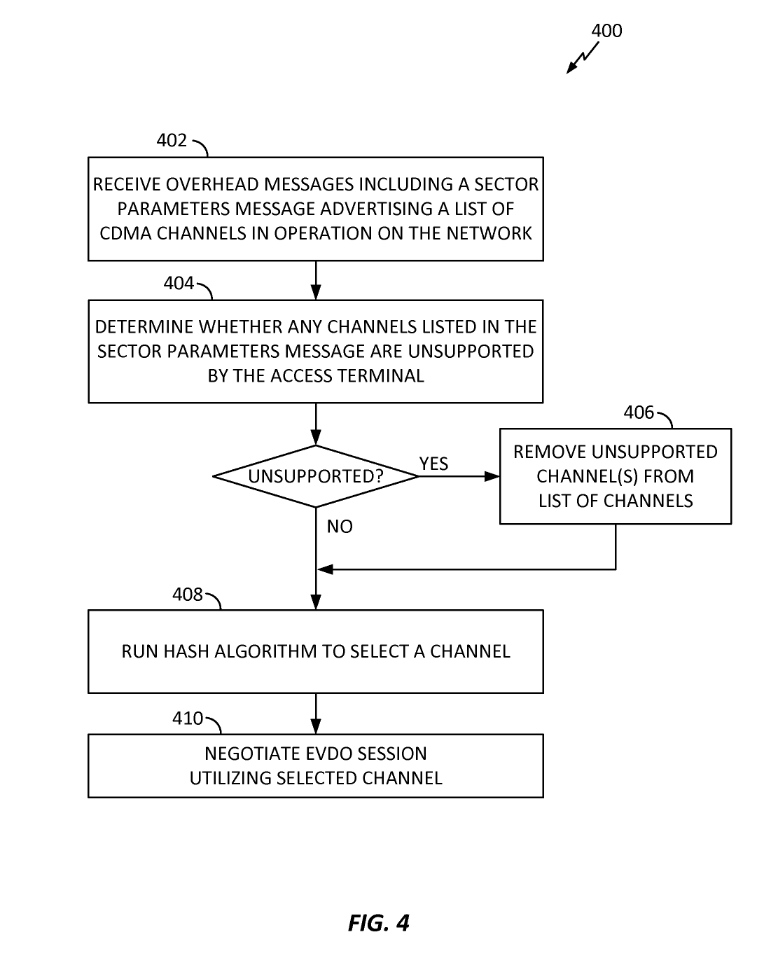

FIG. 4 is a flow chart illustrating an exemplary process 400 in accordance with an aspect of the present disclosure. In some examples, the process 400 may be implemented by the access terminal 104 (e.g., the access terminal 304). In another example, the process 400 may be implemented by any suitable apparatus or means for performing the functions described herein.

At block 402, the access terminal may receive one or more overhead messages. For example, the access terminal may receive a sector parameters (SP) message, advertising a list of CDMA channels in operation on the network. Here, the access terminal may store the received list of channels in memory.

At block 404, the access terminal may determine whether any of the channels listed in the received overhead message are unsupported. For example, the access terminal may be configured to support only a limited set of channels and/or band classes, and may accordingly compare the list of channels in the received list with a list of supported channels, to determine whether any one or more of the listed channels are not in a list of supported channels.

If one or more channels in the received list are unsupported, then at block 406 the access terminal may remove the one or more unsupported channels from the list of channels. For example, if the received list of channels is stored in memory, the list in memory may be updated to not include any of the unsupported channels. In another example, a second list may be generated, including only the supported channels from the list of channels received in the SP message. Thus, in some aspects, the operations of block 406 involve generating a subset list of channels that excludes any channels that are not supported by the access terminal.

At block 408, the access terminal may run a hash algorithm to select a channel, utilizing the channel list that excludes any channels that are not supported by the access terminal. As a result of running the hash algorithm, the access terminal may select a channel, and at block 410, the access terminal may negotiate an EVDO session utilizing the selected channel.

At the time of the session negotiation at block 410, the access network may become informed of the Idle State Protocol subtype currently being used by the access terminal Both the access terminal and the access network may thus run (execute) identical hash algorithms and thereby agree on a common channel to be used for subsequent communication between these nodes.

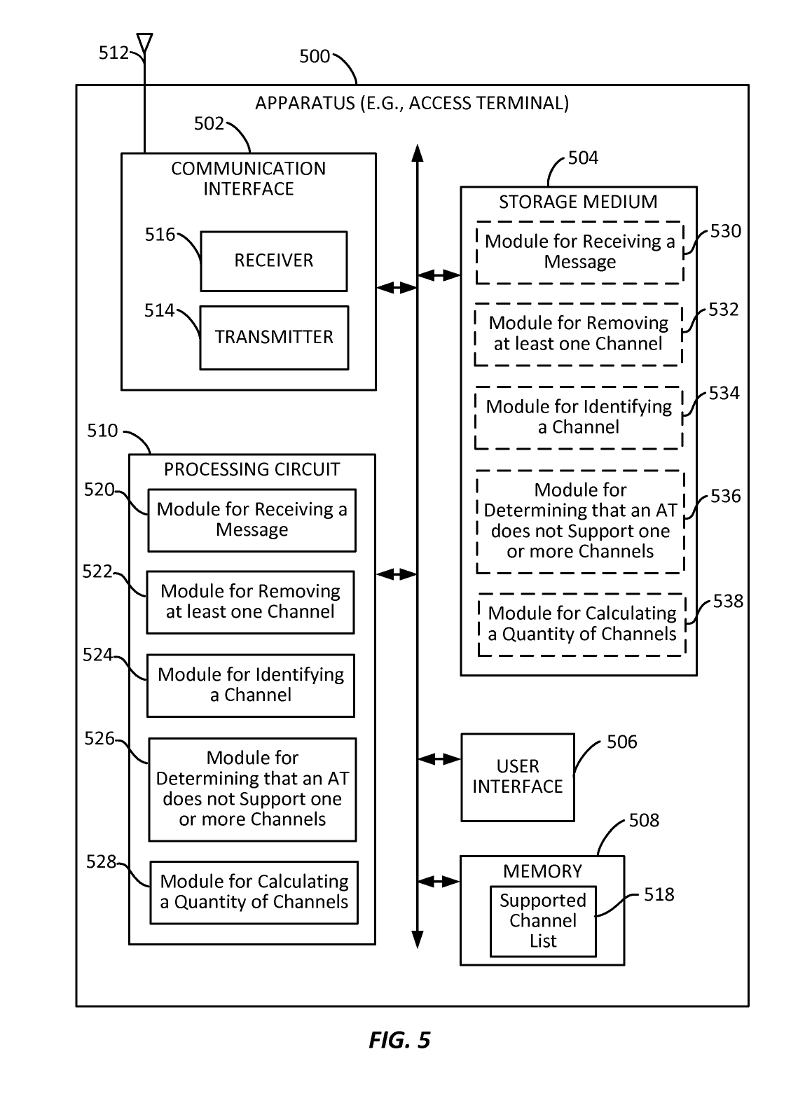

FIG. 5 is an illustration of an exemplary apparatus 500 (e.g., the access terminal 104) configured according to one or more aspects of the present disclosure. The apparatus 500 includes a communication interface (e.g., at least one transceiver) 502, a storage medium 504, a user interface 506, a memory 508, and a processing circuit 510. These components can be coupled to and/or placed in electrical communication with one another via a signaling bus or other suitable component. In particular, each of the communication interface 502, the storage medium 504, the user interface 506, and the memory 508 are coupled to and/or in electrical communication with the processing circuit 510.

The communication interface 502 may be adapted to facilitate wireless communication of the apparatus 500. For example, the communication interface 502 may include circuitry and/or programming adapted to facilitate the communication of information bi-directionally with respect to one or more communication devices in a network. The communication interface 502 may be coupled to one or more antennas 512 for wireless communication within a wireless communication system. The communication interface 502 can be configured with one or more standalone receivers and/or transmitters, as well as one or more transceivers. In the illustrated example, the communication interface 502 includes a transmitter 514 and a receiver 516.

The memory 508 may represent one or more memory devices. As indicated, the memory 508 may store a supported channel list 518 along with other information used by the apparatus 500. In some implementations, the memory 508 and the storage medium 504 are implemented as a common memory component. The memory 508 may also be used for storing data that is manipulated by the processing circuit 510 or some other component of the apparatus 500.

The storage medium 504 may represent one or more computer-readable, machine-readable, and/or processor-readable devices for storing programming, such as processor executable code or instructions (e.g., software, firmware), electronic data, databases, or other digital information. The storage medium 504 may also be used for storing data that is manipulated by the processing circuit 510 when executing programming. The storage medium 504 may be any available media that can be accessed by a general purpose or special purpose processor, including portable or fixed storage devices, optical storage devices, and various other mediums capable of storing, containing or carrying programming.

By way of example and not limitation, storage medium 504 may comprise a storage device that includes a magnetic storage device (e.g., hard disk, floppy disk, magnetic strip), an optical disk (e.g., a compact disc (CD) or a digital versatile disc (DVD)), a smart card, a flash memory device (e.g., a card, a stick, or a key drive), a random access memory (RAM), a read only memory (ROM), a programmable ROM (PROM), an erasable PROM (EPROM), an electrically erasable PROM (EEPROM), a register, a removable disk, or any other suitable storage device for storing software and/or instructions that may be accessed and read by a computer or a communication device. The storage medium 504 may be embodied in an article of manufacture (e.g., a computer program product). By way of example, a computer program product may include a computer-readable medium in packaging materials. Thus, in some implementations, the storage medium may be a non-transitory (e.g., tangible) storage medium.

Alternatively, in some implementations, a computer-readable medium may include, by way of example, a carrier wave, a transmission line, and any other suitable medium for transmitting software and/or instructions that may be accessed and read by a computer.

The storage medium 504 may be coupled to the processing circuit 510 such that the processing circuit 510 can read information from, and write information to, the storage medium 504. That is, the storage medium 504 can be coupled to the processing circuit 510 so that the storage medium 504 is at least accessible by the processing circuit 510, including examples where at least one storage medium is integral to the processing circuit 510 and/or examples where at least one storage medium is separate from the processing circuit 510 (e.g., resident in the apparatus 500, external to the apparatus 500, distributed across multiple entities).

Programming stored by the storage medium 504, when executed by the processing circuit 510, causes the processing circuit 510 to perform one or more of the various functions and/or process steps described herein. For example, the storage medium 504 may include operations configured for regulating operations at one or more hardware blocks of the processing circuit 510, as well as to utilize the communication interface 502 for wireless communication utilizing their respective communication protocols.

The processing circuit 510 is generally adapted for processing, including the execution of such programming stored on the storage medium 504. As used herein, the term “programming” or the term “code” shall be construed broadly to include without limitation instructions, instruction sets, data, code, code segments, program code, programs, subprograms, software modules, applications, software applications, software packages, routines, subroutines, objects, executables, threads of execution, procedures, functions, programming, etc., whether referred to as software, firmware, middleware, microcode, hardware description language, or otherwise.

The processing circuit 510 is arranged to obtain, process and/or send data, control data access and storage, issue commands, and control other desired operations. The processing circuit 510 may include circuitry configured to implement desired programming provided by appropriate media in at least one example. For example, the processing circuit 510 may be implemented as one or more processors, one or more controllers, and/or other structure configured to execute executable programming. Examples of the processing circuit 510 may include a general purpose processor, a digital signal processor (DSP), an application specific integrated circuit (ASIC), a field programmable gate array (FPGA) or other programmable logic component, discrete gate or transistor logic, discrete hardware components, or any combination thereof designed to perform the functions described herein. A general purpose processor may include a microprocessor, as well as any conventional processor, controller, microcontroller, or state machine. The processing circuit 510 may also be implemented as a combination of computing components, such as a combination of a DSP and a microprocessor, a number of microprocessors, one or more microprocessors in conjunction with a DSP core, an ASIC and a microprocessor, or any other number of varying configurations. These examples of the processing circuit 510 are for illustration and other suitable configurations within the scope of the present disclosure are also contemplated.

According to one or more aspects of the present disclosure, the processing circuit 510 may be adapted to perform any or all of the features, processes, functions, steps and/or routines for any or all of the apparatuses described herein. As used herein, the term “adapted” in relation to the processing circuit 510 may refer to the processing circuit 510 being one or more of configured, employed, implemented, and/or programmed to perform a particular process, function, step and/or routine according to various features described herein.

According to at least one example of the apparatus 500, the processing circuit 510 may include a module for receiving a message 520, a module for generating a subset list of channels 522, a module for identifying a channel 524, a module for determining that an access terminal (AT) does not support one or more channels 526, and a module for calculating a quantity of channels 528.

The module for receiving a message 520 may include circuitry and/or programming adapted to perform several functions relating to, for example, receiving a message that comprises a list of channels. One of these functions involves invoking a transfer of specific data from another component. For example, the receiver 516 of the apparatus 500 can be configured to monitor for broadcast signals from an access point and decode the broadcast signals to derive a message that is encoded in the broadcast signals. Another one of these functions involves acquiring the transferred data. For example, the module for receiving a message 520 may receive a message comprising a list of channels from the receiver 516. Another one of these functions involves storing the data for access by another component of the processing circuit or some other component of the apparatus 500. For example, the module for receiving a message 520 may store the message acquired in the previous function in a specified memory location in the memory 508. In some implementations, the programming referred to above comprises a module for receiving a message 530 stored on the storage medium 504.

The module for generating a subset list of channels 522 may include circuitry and/or programming adapted to perform several functions relating to, for example, generating a subset list of channels by removing a channel entry from a list of channels. One of these functions involves acquiring a list of channels. For example, the module for removing at least one channel 522 may retrieve the list of channels that the module for receiving a message 520 stored in the memory 508. Another one of these functions involves acquiring information that indicates which channels should not be in the list. In some implementations, an access terminal removes any channel from the list that is not supported by the access terminal. For example, a low-cost access terminal may have a limited hardware configuration that only supports some of the channels that are in operation in the network. Accordingly, a list of supported channels and/or a list of non-supported channels can be stored in the memory 508 or in some other manner. The module for removing at least one channel 522 can therefore retrieve such a list to identify which channels should not be in a channel list that will be used by the apparatus 500. Another one of these functions involves evaluating the list to determine whether to remove any channels. For example, the received list of channels can be compared with a list of supported channels (as discussed in the previous function) to identify any channels that should be removed from the list of channels. Another one of these functions involves removing any channels as needed from the original channel list to generate a subset of the channel list. The act of removing a channel from a list can involve, for example, removing a channel entry from a list, setting a parameter that indicates that a channel has been removed from consideration, or generating a new list that does not include a removed channel. In some implementations, the programming referred to above comprises a module for generating a subset list of channels 532 stored on the storage medium 504.

The module for identifying a channel 524 may include circuitry and/or programming adapted to perform several functions relating to, for example, identifying a channel to be used for communication from a subset list of prospective channels. One of these functions involves acquiring a subset list of channels. For example, upon receipt of a list, an access terminal may store the list in a specified memory location. Thus, the module for identifying a channel 524 can retrieve this list from the specified memory location. Another one of these functions involves acquiring input parameters for an algorithm. For example, the channel selection hash algorithm specified in 3GPP2 C.S0024-B v3.0 discussed above can employ three input parameters: a key (e.g., an access terminal identifier), a de-correlation parameter, and the number of channels in a table from which the channel is selected. Each of these parameters may be stored in a specified memory location. Thus, the module for identifying a channel 524 can retrieve these parameters from the specified memory location. Another one of these functions involves invoking an algorithm that operates to identify a channel. For example, a hash algorithm that selects a channel from a list based on the input parameters acquired in the previous function may be invoked. An example of such a hash algorithm is specified in 3GPP2 C.S0024-B v3.0 discussed above. Another one of these functions involves outputting an indication of the identified channel. For example, an identifier of the channel identified by the above hash algorithm may be stored in a specified memory location or passed to another function. In some implementations, the programming referred to above comprises a module for identifying a channel 534 stored on the storage medium 504.

Further, the module for determining that an AT does not support one or more channels 526 may include circuitry and/or programming adapted to perform several functions relating to, for example, identifying a channel that is not supported by an AT. One of these functions involves receiving an indication that a determination is to be made as to any channels not supported by an AT. For example, a function that acquires a channel list as discussed above may generate an indication (e.g., a function call) to determine whether any there are any channels that are not supported by the AT. Another one of these functions involves acquiring information that indicates which channels are supported by the AT and/or which channels are not supported by the AT. For example, a low-cost access terminal may have a limited hardware configuration that only supports some of the channels that are in operation in the network. Accordingly, a list of supported channels and/or a list of non-supported channels can be stored in the memory 508 or in some other manner. The module for determining that an AT does not support one or more channels 526 can therefore retrieve such a list to identify which channels are or are not supported by the apparatus 500. Another one of these functions involves outputting an indication of one or more channels that are not supported by the AT. For example, the above indication may be stored in a specified memory location or passed to another function. In some implementations, the programming referred to above comprises a module for determining that an AT does not support one or more channels 536 stored on the storage medium 504).

Also, the module for calculating a quantity of channels 528 may include circuitry and/or programming adapted to perform several functions relating to, for example, determining how many channels are listed in a list of channels. One of these functions involves acquiring a channel list. For example, upon receipt of a list, an access terminal may store the list in a specified memory location. Thus, the module for calculating a quantity of channels 528 can retrieve this list from the specified memory location. Another one of these functions involves performing an algorithm that operates on the list to determine how many channels are listed in the channel list. For example, each channel entry in the list may be indicated by an entry number. In this case, determining how many channel entries are in the list may involve determining the highest entry number. Another one of these functions involves outputting an indication of the number of channels listed in the channel list. For example, a number that indicates the number of channels determined in the previous function can be stored in a specified memory location. In some implementations, the programming referred to above comprises a module for calculating a quantity of channels 538 stored on the storage medium 504.

As mentioned above, programming stored by the storage medium 504, when executed by the processing circuit 510, causes the processing circuit 510 to perform one or more of the various functions and/or process steps described herein. For example, the storage medium 504 may include one or more of the module (e.g., operations) for receiving a message 530, the module for generating a subset list of channels 532, the module for identifying a channel 534, the module for determining that an access terminal (AT) does not support one or more channels 536, and the module for calculating a quantity of channels 538.

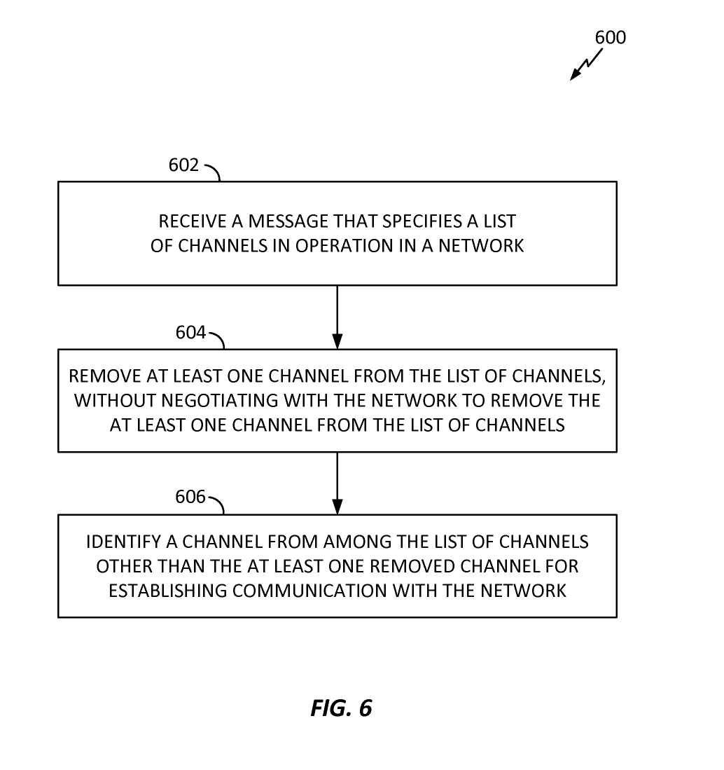

FIG. 6 illustrates a process 600 for channel identification operations in accordance with some aspects of the present disclosure. The process 600 may take place within a processing circuit 510 (FIG. 5), which may be located at an access terminal or some other suitable apparatus. In another aspect, the process 600 may be implemented by the access terminal 104 illustrated in FIG. 1. Of course, in various aspects within the scope of the present disclosure, the process 600 may be implemented by any suitable apparatus capable of supporting channel identification operations.

In block 602, at some point in time, a message that specifies a list of channels in operation in a network is received. As discussed herein, in some implementations, the message is a 3GPP2 sector parameters message. Other types of messages can be received in implementations based on other technologies.

In block 604, a subset list of channels is generated by removing at least one channel from the list of channels. This removal may be accomplished in various ways. In some implementations, a channel entry is explicitly removed from the list to generate the subset list. For example, the entry for that channel may be deleted from the list. In some implementations, a channel is implicitly removed from the list to generate the subset list. For example, a channel entry may be removed from a list by designated the channel entry as being removed (e.g., the entry is designated as being excluded, invalid, disqualified, and so on). Thus, in some aspects, the removal of the at least one channel from the list of channels may comprise storing an indication that each of the at least one channel from the list of channels is excluded from consideration for establishing the communication with the network.

Of note, the removal is done without negotiating with the network to remove the at least one channel from the list of channels. That is, the access terminal autonomously removes the at least one channel. For example, the operations of block 604 may be performed by an access terminal that does not have an Enhanced Voice-Data Optimized (EVDO) session negotiated with a base station of the network (e.g., the access terminal is operating under the Default Idle State Protocol).

In block 606, a channel from the subset list of channels is identified for establishing communication with the network. For example, a hash algorithm may be invoked to select one of the channels in the subset list of channels. Initial communication with the network (e.g., .an access network) may thus be established via the identified channel.

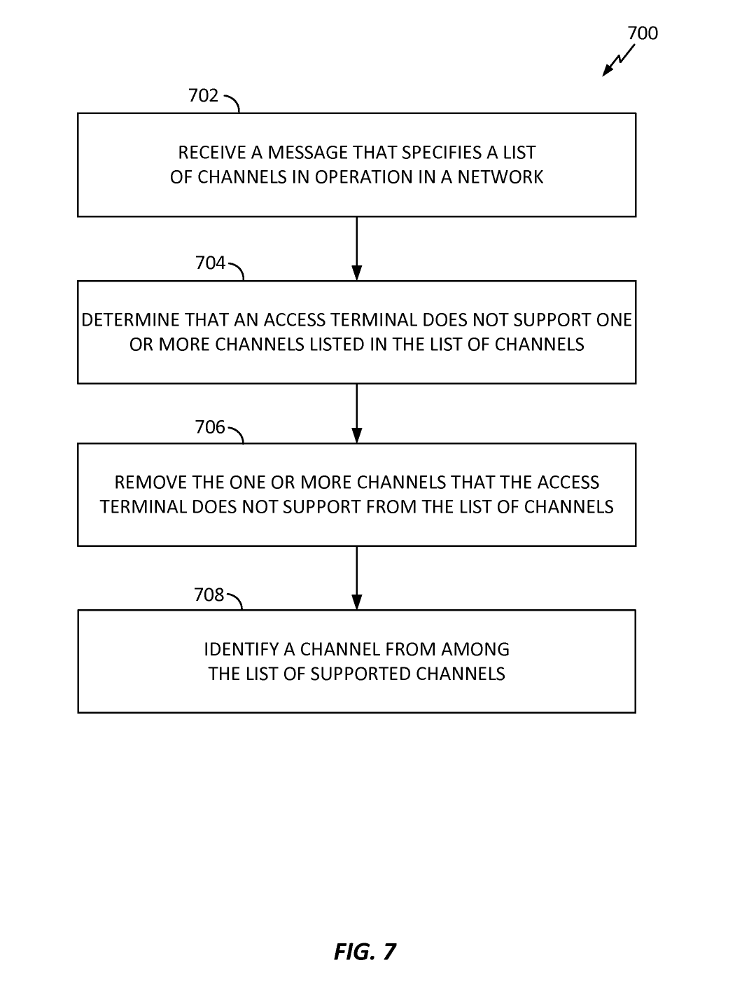

FIG. 7 illustrates a process 700 for channel identification operations in accordance with other aspects of the present disclosure. The process 700 may take place within a processing circuit 510 (FIG. 5), which may be located at an access terminal or some other suitable apparatus. In another aspect, the process 700 may be implemented by the access terminal 104 illustrated in FIG. 1. Of course, in various aspects within the scope of the present disclosure, the process 700 may be implemented by any suitable apparatus capable of supporting channel identification operations.

In block 702, a message that specifies a list of channels in operation in a network is received. In some aspects, the operations of block 702 may be similar to the operations of block 602 described above.

In block 704, a determination is made that an access terminal does not support one or more channels listed in the list of channels. For example, the operations of block 704 may involve determining that hardware of the access terminal does not support the one or more channels.

In block 706, the one or more channels the access terminal does not support is/are removed from the list of channels to generate a subset list of channels. In some aspects, these operations may be similar to the operations of block 604 discussed above.

In block 708, a channel from among the subset list of supported channels is identified for establishing communication with the network. Here, the supported channels comprise the channels other than the one or more removed channel(s). In some aspects, the operations of block 708 may be similar to the operations of block 606 described above.

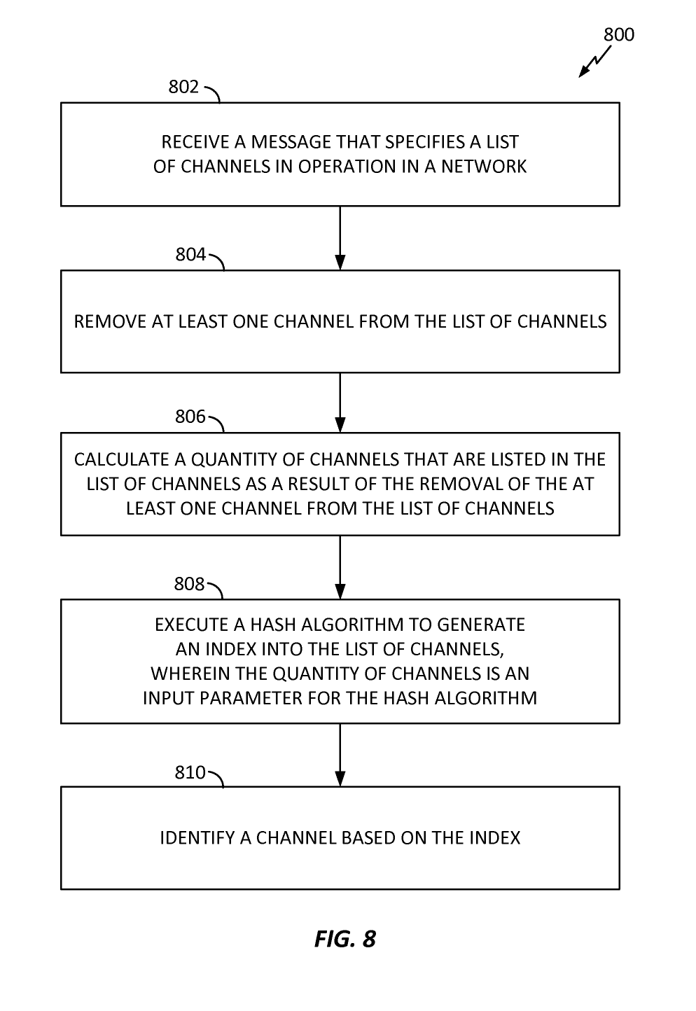

FIG. 8 illustrates a process 800 for channel identification operations in accordance with still other aspects of the present disclosure. The process 800 may take place within a processing circuit 510 (FIG. 5), which may be located at an access terminal or some other suitable apparatus. In another aspect, the process 800 may be implemented by the access terminal 104 illustrated in FIG. 1. Of course, in various aspects within the scope of the present disclosure, the process 800 may be implemented by any suitable apparatus capable of supporting channel identification operations.

In block 802, a message that specifies a list of channels in operation in a network is received. In some aspects, the operations of block 802 may be similar to the operations of block 602 described above.

In block 804, at least one channel is removed from the list of channels to generate a subset list of channels. In some aspects, the operations of block 804 may be similar to the operations of block 604 described above.

In block 806, a quantity of channels that are listed in the subset list of channels as a result of the removal of the at least one channel from the list of channels is calculated. For example, the number of channels in the list that are supported by the access terminal may be determined

In block 808, a hash algorithm is executed to generate an index into the subset list of channels. Here, the quantity of channels calculated at block 806 is an input parameter for the hash algorithm. As discussed herein, the hash algorithm may generate an index into the list of channels. For example, and without limitation, a channel selection hash algorithm as specified in 3GPP2 C.S0024-B v3.0 may be employed here. Such a hash algorithm can employ three input parameters: a key (e.g., an access terminal identifier), a de-correlation parameter, and the number of channels in a channel table. Based on these input parameters, the hash algorithm generates an index that corresponds to one of the channels in the channel list.

In block 810, a channel from the list of channels (after the removal of block 804) is identified based on the index generated at block 808.

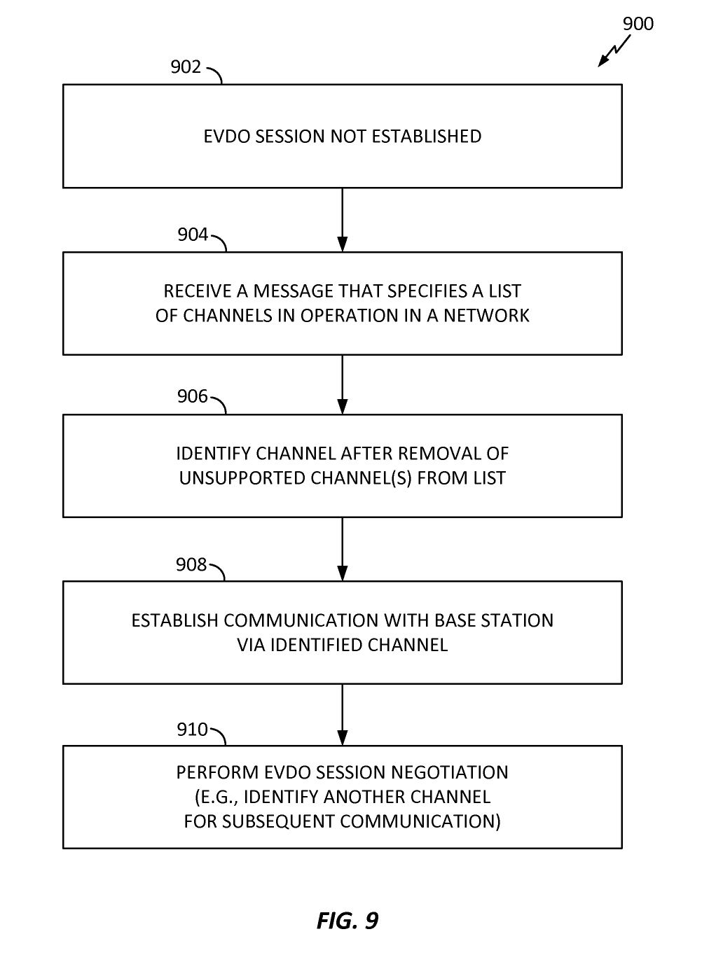

FIG. 9 illustrates a process 900 for 3GPP2 communication operations in accordance with some aspects of the present disclosure. The process 900 may take place within a processing circuit 510 (FIG. 5), which may be located at an access terminal or some other suitable apparatus. In another aspect, the process 900 may be implemented by the access terminal 104 illustrated in FIG. 1. Of course, in various aspects within the scope of the present disclosure, the process 900 may be implemented by any suitable apparatus capable of supporting communication operations.

In block 902, initially, an EVDO session is not established. For example, an access terminal may have recently been powered-on or reset, or the access terminal may have recently entered coverage of an access network. In addition, the access terminal may be operating under the Default Idle State Protocol.

In block 904, a message that specifies a list of channels in operation in a network is received. In some aspects, the operations of block 904 may be similar to the operations of block 602 described above.

In block 906, a channel is identified after the removal of any unsupported channels from the list. In some aspects, the operations of block 906 may be similar to the operations of blocks 604 and 606 and/or blocks 704-708 described above.

In block 908, communication is established with a base station via the channel identified at block 906. For example, an access terminal may attempt to receive messages from the base station and/or transmit messages to the base station on the identified channel.

In block 910, EVDO session negotiation is performed. For example, the access terminal and the base station may communicate over the channel identified in block 906 to establish an EVDO session. Of note, this negotiation is performed after the removal of the channel(s) from the list at block 906. In some cases, the negotiation of block 910 may involve identifying another channel (other than the channel identified at block 906) for subsequent communication between the access terminal and the base station.

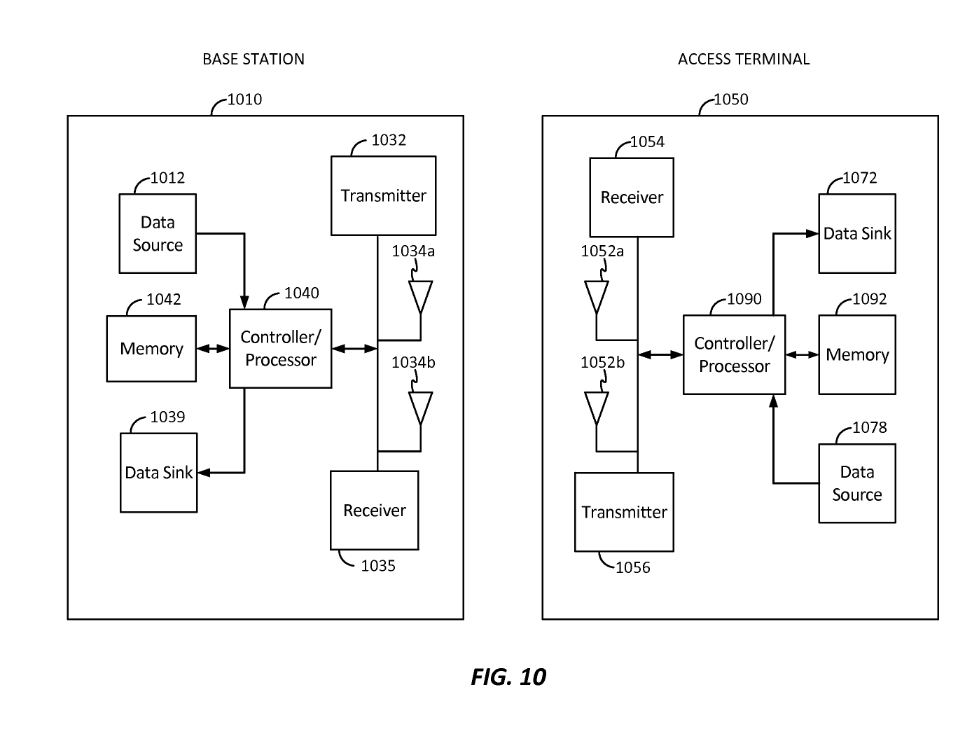

FIG. 10 is a block diagram of an exemplary base station 1010 in communication with an exemplary access terminal 1050, where the base station 1010 may be the base station 102 in FIG. 1, and the access terminal 1050 may be the access terminal 104 in FIG. 1. In the downlink communication, a controller or processor 1040 may receive data from a data source 1012. Channel estimates may be used by a controller/processor 1040 to determine the coding, modulation, spreading, and/or scrambling schemes for the transmit processor 1020. These channel estimates may be derived from a reference signal transmitted by the access terminal 1050 or from feedback from the access terminal 1050. A transmitter 1032 may provide various signal conditioning functions including amplifying, filtering, and modulating frames onto a carrier for downlink transmission over a wireless medium through one or more antennas 1034. The antennas 1034 may include one or more antennas, for example, including beam steering bidirectional adaptive antenna arrays, MIMO arrays, or any other suitable transmission/reception technologies.

At the access terminal 1050, a receiver 1054 receives the downlink transmission through one or more antennas 1052 and processes the transmission to recover the information modulated onto the carrier. The information recovered by the receiver 1054 is provided to a controller/processor 1090. The processor 1090 descrambles and despreads the symbols, and determines the most likely signal constellation points transmitted by the base station 1010 based on the modulation scheme. These soft decisions may be based on channel estimates computed by the processor 1090. The soft decisions are then decoded and deinterleaved to recover the data, control, and reference signals. The CRC codes are then checked to determine whether the frames were successfully decoded. The data carried by the successfully decoded frames will then be provided to a data sink 1072, which represents applications running in the access terminal 1050 and/or various user interfaces (e.g., display). Control signals carried by successfully decoded frames will be provided to a controller/processor 1090. When frames are unsuccessfully decoded, the controller/processor 1090 may also use an acknowledgement (ACK) and/or negative acknowledgement (NACK) protocol to support retransmission requests for those frames.

In the uplink, data from a data source 1078 and control signals from the controller/processor 1090 are provided. The data source 1078 may represent applications running in the access terminal 1050 and various user interfaces (e.g., keyboard). Similar to the functionality described in connection with the downlink transmission by the base station 1010, the processor 1090 provides various signal processing functions including CRC codes, coding and interleaving to facilitate FEC, mapping to signal constellations, spreading with OVSFs, and scrambling to produce a series of symbols. Channel estimates, derived by the processor 1090 from a reference signal transmitted by the base station 1010 or from feedback contained in a midamble transmitted by the base station 1010, may be used to select the appropriate coding, modulation, spreading, and/or scrambling schemes. The symbols produced by the processor 1090 will be utilized to create a frame structure. The processor 1090 creates this frame structure by multiplexing the symbols with additional information, resulting in a series of frames. The frames are then provided to a transmitter 1056, which provides various signal conditioning functions including amplification, filtering, and modulating the frames onto a carrier for uplink transmission over the wireless medium through the one or more antennas 1052.

The uplink transmission is processed at the base station 1010 in a manner similar to that described in connection with the receiver function at the access terminal 1050. A receiver 1035 receives the uplink transmission through the one or more antennas 1034 and processes the transmission to recover the information modulated onto the carrier. The information recovered by the receiver 1035 is provided to the processor 1040, which parses each frame. The processor 1040 performs the inverse of the processing performed by the processor 1090 in the access terminal 1050. The data and control signals carried by the successfully decoded frames may then be provided to a data sink 1039. If some of the frames were unsuccessfully decoded by the receive processor, the controller/processor 1040 may also use an acknowledgement (ACK) and/or negative acknowledgement (NACK) protocol to support retransmission requests for those frames.

The controller/processors 1040 and 1090 may be used to direct the operation at the base station 1010 and the access terminal 1050, respectively. For example, the controller/processors 1040 and 1090 may provide various functions including timing, peripheral interfaces, voltage regulation, power management, and other control functions. The computer readable media of memories 1042 and 1092 may store data and software for the base station 1010 and the access terminal 1050, respectively.

### CONCLUSION

While the above discussed aspects, arrangements, and embodiments are discussed with specific details and particularity, one or more of the components, steps, features and/or functions illustrated in one or more of FIG. 4, 6, 7, 8, or 9 may be rearranged and/or combined into a single component, step, feature or function or embodied in several components, steps, or functions. Additional elements, components, steps, and/or functions may also be added or not utilized without departing from the teachings herein. The apparatus, devices and/or components illustrated in one or more of FIG. 1, 5, or 10 may be configured to perform or employ one or more of the methods, features, parameters, or steps described in one or more of FIG. 4, 6, 7, 8, or 9. The novel algorithms described herein may also be efficiently implemented in software and/or embedded in hardware.

Also, it is noted that at least some implementations have been described as a process that is depicted as a flowchart, a flow diagram, a structure diagram, or a block diagram. Although a flowchart may describe the operations as a sequential process, many of the operations can be performed in parallel or concurrently. In addition, the order of the operations may be re-arranged. A process is terminated when its operations are completed. A process may correspond to a method, a function, a procedure, a subroutine, a subprogram, etc. When a process corresponds to a function, its termination corresponds to a return of the function to the calling function or the main function. The various methods described herein may be partially or fully implemented by programming (e.g., instructions and/or data) that may be stored in a machine-readable, computer-readable, and/or processor-readable storage medium, and executed by one or more processors, machines and/or devices.

Those of skill in the art would further appreciate that the various illustrative logical blocks, modules, circuits, and algorithm steps described in connection with the embodiments disclosed herein may be implemented as hardware, software, firmware, middleware, microcode, or any combination thereof. To clearly illustrate this interchangeability, various illustrative components, blocks, modules, circuits, and steps have been described above generally in terms of their functionality. Whether such functionality is implemented as hardware or software depends upon the particular application and design constraints imposed on the overall system.

The various features associate with the examples described herein and shown in the accompanying drawings can be implemented in different examples and implementations without departing from the scope of the present disclosure. Therefore, although certain specific constructions and arrangements have been described and shown in the accompanying drawings, such embodiments are merely illustrative and not restrictive of the scope of the disclosure, since various other additions and modifications to, and deletions from, the described embodiments will be apparent to one of ordinary skill in the art. Thus, the scope of the disclosure is only determined by the literal language, and legal equivalents, of the claims which follow.

What is claimed is:

1. A method of wireless communication, comprising:
receiving a message that specifies a list of channels in operation in a network;
generating a subset list of channels by removing at least one channel from the list of channels without negotiating with the network to remove the at least one channel from the list of channels; and
identifying a channel from the subset list of channels for establishing communication with the network.

2. The method of claim 1, further comprising:
determining that the access terminal does not support one or more channels listed in the list of channels; and
removing the one or more channels the access terminal does not support from the list of channels.

3. The method of claim 2, further comprising determining that hardware of the access terminal does not support the one or more channels.

4. The method of claim 1, further comprising storing an indication that each of the at least one channel from the list of channels is excluded from consideration for establishing the communication with the network.

5. The method of claim 1, further comprising:
calculating a quantity of channels that are listed in the subset list of channels as a result of the removal of the at least one channel from the list of channels; and
executing a hash algorithm to generate an index into the subset list of channels,
wherein the quantity of channels is an input parameter for the hash algorithm.

6. The method of claim 1, further comprising removing the at least one channel without having an Enhanced Voice-Data Optimized (EVDO) session negotiated with a base station of the network.

7. The method of claim 1, further comprising performing an Enhanced Voice-Data Optimized (EVDO) session negotiation with a base station of the network after the removal of the at least one channel from the list of channels.

8. An apparatus configured for wireless communication, comprising:
at least one processing circuit;
a memory coupled to the at least one processing circuit; and
a communication interface coupled to the at least one processing circuit,
wherein the at least one processing circuit is configured to:
receive a message that specifies a list of channels in operation in a network;
generate a subset list of channels by removing at least one channel from the list of channels without negotiating with the network to remove the at least one channel from the list of channels; and
identify a channel from the subset list of channels for establishing communication with the network.

9. The apparatus of claim 8, wherein the at least one processing circuit is further configured to:
determine that the apparatus does not support one or more channels listed in the list of channels; and
remove the one or more channels the apparatus does not support from the list of channels.

10. The apparatus of claim 9, wherein the at least one processing circuit is further configured to determine that hardware of the apparatus does not support the one or more channels.

11. The apparatus of claim 8, wherein the at least one processing circuit is further configured to store an indication that each of the at least one channel from the list of channels is excluded from consideration for establishing the communication with the network.

12. The apparatus of claim 8, wherein:
the at least one processing circuit is further configured to calculate a quantity of channels that are listed in the subset list of channels as a result of the removal of the at least one channel from the list of channels;
the at least one processing circuit is further configured to execute a hash algorithm to generate an index into the subset list of channels; and
the quantity of channels is an input parameter for the hash algorithm.

13. The apparatus of claim 8, wherein the at least one processing circuit is further configured to remove the at least one channel without having an Enhanced Voice-Data Optimized (EVDO) session negotiated with a base station of the network.

14. The apparatus of claim 8, wherein the at least one processing circuit is further configured to perform an Enhanced Voice-Data Optimized (EVDO) session negotiation with a base station of the network after the removal of the at least one channel from the list of channels.

15. An apparatus configured for wireless communication, comprising:
means for receiving a message that specifies a list of channels in operation in a network;
means for generating a subset list of channels by removing at least one channel from the list of channels without negotiating with the network to remove the at least one channel from the list of channels; and
means for identifying a channel from the subset list of channels for establishing communication with the network.

16. The apparatus of claim 15, further comprising:
means for determining that the apparatus does not support one or more channels listed in the list of channels,
wherein the means for generating is configured to remove the one or more channels the apparatus does not support from the list of channels.

17. The apparatus of claim 16, wherein the means for generating is configured to determine that hardware of the apparatus does not support the one or more channels.

18. The apparatus of claim 15, further comprising:
means for calculating a quantity of channels that are listed in the subset list of channels as a result of the removal of the at least one channel from the list of channels,
wherein the means for identifying the channel is configured to execute a hash algorithm to generate an index into the subset list of channels, and
wherein the quantity of channels is an input parameter for the hash algorithm.

19. The apparatus of claim 15, wherein the means for generating the subset list of channels is configured to remove the at least one channel without having an Enhanced Voice-Data Optimized (EVDO) session negotiated with a base station of the network.

20. The apparatus of claim 15, further comprising means for performing an Enhanced Voice-Data Optimized (EVDO) session negotiation with a base station of the network after the removal of the at least one channel from the list of channels.

21. An article of manufacture comprising:
a computer-readable storage device comprising code for causing a communication device to:
receive a message that specifies a list of channels in operation in a network;
generate a subset list of channels by removing at least one channel from the list of channels without negotiating with the network to remove the at least one channel from the list of channels; and
identify a channel from the subset list of channels for establishing communication with the network.

22. The article of manufacture of claim 21, wherein the computer-readable medium further comprises code for causing the communication device to:
determine that an access terminal does not support one or more channels listed in the list of channels; and
remove the one or more channels the access terminal does not support from the list of channels.

23. The article of manufacture of claim 22, wherein the computer-readable medium further comprises code for causing the communication device to determine that hardware of the access terminal does not support the one or more channels.

24. The article of manufacture of claim 21, wherein:
the computer-readable medium further comprises code for causing the communication device to calculate a quantity of channels that are listed in the subset list of channels as a result of the removal of the at least one channel from the list of channels;
the computer-readable medium further comprises code for causing the communication device to execute a hash algorithm to generate an index into the subset list of channels; and
the quantity of channels is an input parameter for the hash algorithm.

25. The article of manufacture of claim 21, wherein the computer-readable medium further comprises code for causing the communication device to remove the at least one channel without having an Enhanced Voice-Data Optimized (EVDO) session negotiated with a base station of the network.

26. The article of manufacture of claim 21, wherein the computer-readable medium further comprises code for causing the communication device to perform an Enhanced Voice-Data Optimized (EVDO) session negotiation with a base station of the network after the removal of the at least one channel from the list of channels.
